(19) United States
(12) Patent Application Publication
(10) Pub. No.: US 2004/0036420 A1
(43) Pub. Date: Feb. 26, 2004

(54) Display power supply

(76) Inventor: Andrew Stubbings, Norfolk (GB)

Correspondence Address: NIXON & VANDERHYE, PC, 1100 N GLEBE ROAD, 8TH FLOOR, ARLINGTON, VA, 22201-4714, US

(21) Appl. No.: 10/297,665

(22) PCT Filed: Jun. 11, 2001
(86) PCT No.: PCT/GB01/02540

(30) Foreign Application Priority Data
Jun. 9, 2000 (GB) 0014178.8

(51) Int. Cl. G09G 3/10

(52) U.S. Cl. 315/169.1; 315/291; 315/224

(57) ABSTRACT

A power supply circuit for a vacuum fluorescent display wherein the supply circuit includes a filament cathode drive voltage (50) and a grid/anode voltage (38) generation circuit combined on a common output stage.

This invention relates to supply circuit arrangements, in particular but not exclusively for vacuum fluorescent display devices. These devices may be found in, for example, gaming machines and cash registers.

Display devices, for example of the kind mentioned above, require a power supply to power the heated cathode (filament), control grids and phosphor-coated anode. For example, the power supply for the filament may be between 2 and 15V AC with a current consumption within the range from 20 mA up to 500 mA. The control grids and anodes can operate from 12 VDC to 120V peak-to-peak at currents ranging from 5 mA to 60 mA.

Traditionally, these voltages have been obtained from a DC/DC converter that uses a transformer and/or wound inductor. However, such inductive circuits can result in interference, high power supply ripple and high peak currents. Alternative circuits using semiconductor switching to provide only the filament with an AC supply have been used, or those using DC voltages and single pulse drive have been proposed but are often not practical with long length displays and can result in detrimental filament operation.

The grid/anode supply has been achieved by rectifying the back EMF generated when switching off an inductor and/or using a voltage multiplier with diode/capacitor stages.

Such circuit arrangements as these tend to be bulky, by modern standards and have a low efficiency rating. In addition, where a semiconductor circuit drives the filament, the external clock input, when an external clock is provided, does not allow a variable duty cycle, so the filament receives 12V at a 50/50 duty cycle. This, in turn, requires additional resistors to drop the voltage, for example to 7.1 V in the case where the circuit employs a vacuum fluorescent display of type DN2029A.

The present invention aims to overcome or mitigate some or all of the above problems, preferably in a simple and economic manner.

According to a first aspect of the invention, there is provided a power supply circuit for a vacuum fluorescent display, the supply circuit including a filament drive and a grid/anode voltage generation circuit combined on a common output drive stage.

By arranging for the drive for the filament and the grid/anode voltage circuit to be combined, the supply circuit can be made more efficient and/or smaller.

Preferably, the supply circuit includes an oscillator circuit.

According to a second aspect of the invention, there is provided a power supply circuit for a vacuum fluorescent display comprising:

an oscillator circuit having a first output for providing a first voltage and a second output for connection to a voltage multiplying circuit.

Thus the filament drive and grid/anode voltage generation circuit can be combined.

Embodiments of the invention can obviate the need for inductors and/or transformers in the voltage multiplying circuit. It is thereby capable of halving the thickness of the display subassembly device, typically from 25 mm to 13 mm, and at the same time decreasing the power dissipation so that, in an example described below the circuit can be de-rated to less than 400 mW at 70° C. In some variants of the power supply circuit, the overall thickness can be as little as 2.5 mm.

Preferably, the first voltage provides a drive voltage for the filament cathode of the display.

Preferably the circuit further includes a voltage multiplying circuit connected to the oscillator circuit, the output of the voltage multiplying circuit providing a second supply voltage.

Preferably, the output of the said voltage multiplying circuit provides drive voltage for the grid/anode of a said vacuum fluorescent display.

Preferably, the voltage multiplying circuit has no inductive components.

The voltage multiplying circuit is preferably a multiple-stage capacitor/diode circuit. The output of the multiplier is preferably stabilised, for example by an emitter-follower circuit.

In embodiments of the invention; the oscillator circuit may comprise an AC driver.

In preferred embodiments, the oscillator circuit comprises an oscillator and a logic circuit, preferably a NAND circuit.

Preferably, the output of the oscillator is split to provide more than one input to the logic circuit. The logic circuit can thus be used to vary the frequency and/or mark/space ratio of the oscillator circuit output.

Preferably, a divide-by-two circuit is used to provide further control of the output.

The logic circuit preferably has a first output which provides the first voltage and a second output for connection to the voltage multiplying circuit. Each output may comprise more than one connection.

In preferred embodiments the oscillator circuit comprises:

an oscillator connected to one input of a logic circuit and via a divide-by-two circuit to another input of the logic circuit,

the output of the logic circuit providing the first supply voltage, and

the logic circuit being connected to a voltage multiplying circuit.

Preferably, the oscillator circuit comprises an oscillator and an integrated circuit having a mark/space ratio control input to which the oscillator is directly connected. In an example below, the oscillator is connected to the SFILCT internal/external clock input.

Preferably, a divide-by-two circuit is connected to the output polarity control input of the integrated circuit. In an example below, the divide-by-two circuit is connected to the BXTERNAL CLOCK input.

The power supply may be provided with means for varying the mark/space ratio or duty cycle ratio of the output of the oscillator. Preferably, the circuit includes a variable amplifier connected to a control input of the oscillator for varying the mark/space ratio or duty cycle ratio.

In a preferred form of the power supply circuit, the oscillator circuit includes an oscillator and a logic circuit comprising a first and a second logic gate, the output of the oscillator being connected to a respective first input of each logic gate, the output of the divide-by-two circuit being connected to a second input of the first logic gate and to the input of an inverter amplifier, the output of said inverter amplifier being connected to the second input of the second logic gate, the outputs of the first and second logic gates providing drive voltages for the filament/cathode of the display, which may be provided either directly or indirectly depending on the output drive current capability of the device, for example on the power of the NAND device or similar output stage.

Preferably, the logic circuit includes NAND gates, Configurations other than NAND are possible, for example AND and/or OR and/or NOR.

Where the said power supply includes an integrated circuit, the said integrated circuit is advantageously a type BD6621FP-Y.

The invention further provides a power supply circuit for a vacuum fluorescent display, comprising an integrated circuit type BD6621FP-Y and an oscillator connected to the SELECT internal or external clock pin of the integrated circuit.

In another aspect of the invention there is provided a power supply circuit for a vacuum fluorescent display, said supply circuit being adapted to generate a power supply for each of a filament drive circuit and a grid/anode circuit of said vacuum fluorescent display from a common drive stage.

In a further aspect of the invention there is provided a power supply circuit for a vacuum fluorescent display comprising a voltage multiplier circuit for connection to a grid/anode circuit of said vacuum fluorescent display, wherein said voltage multiplier circuit has no inductive components.

In a yet further aspect, the invention provides for a method of supplying power to a vacuum fluorescent display using the power supply circuit as herein described.

Also provided by the invention is a display device including a power supply circuit as described herein.

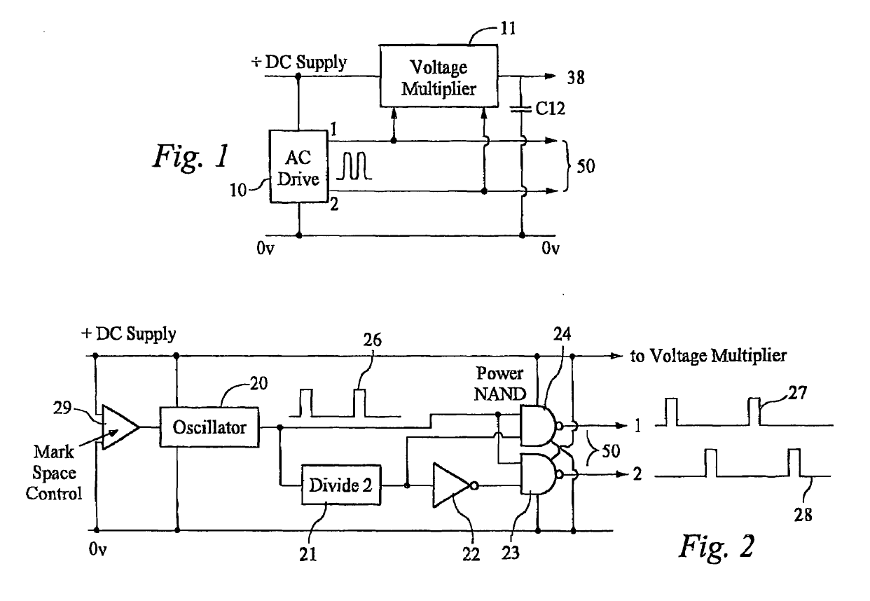

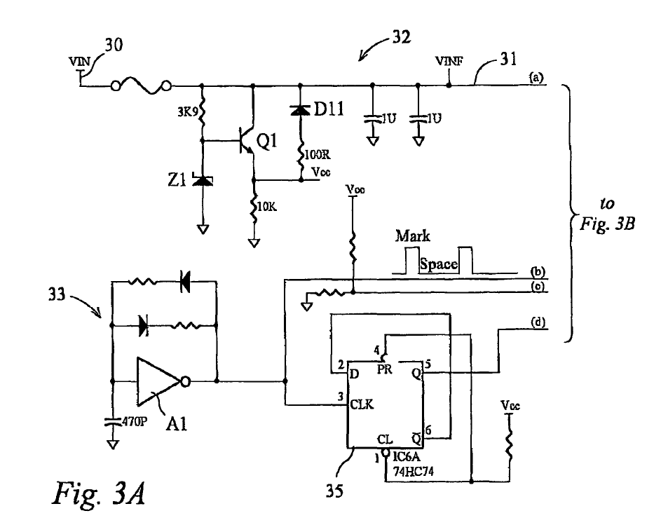

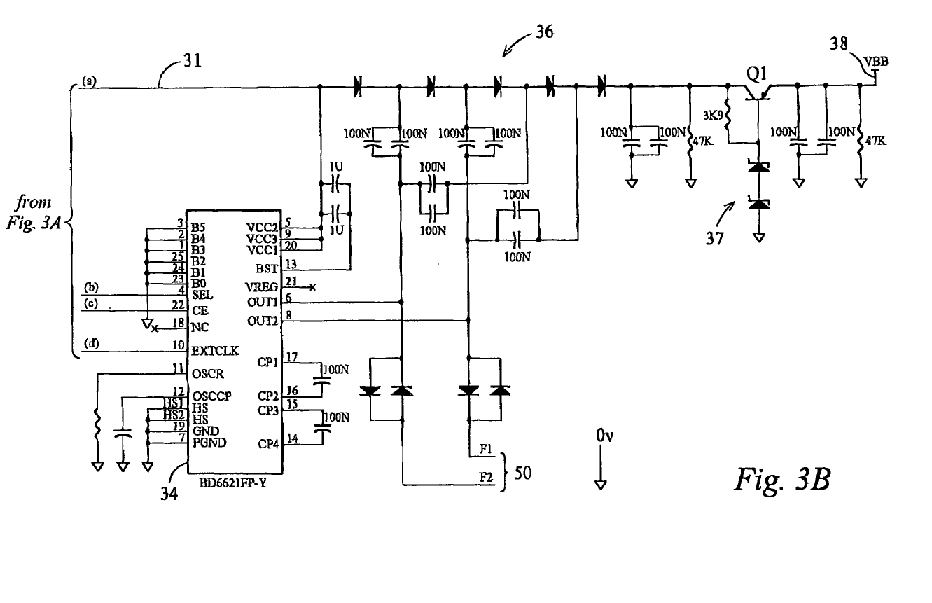

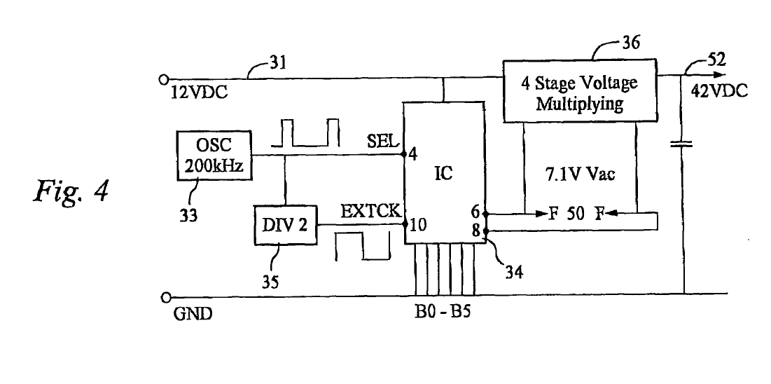

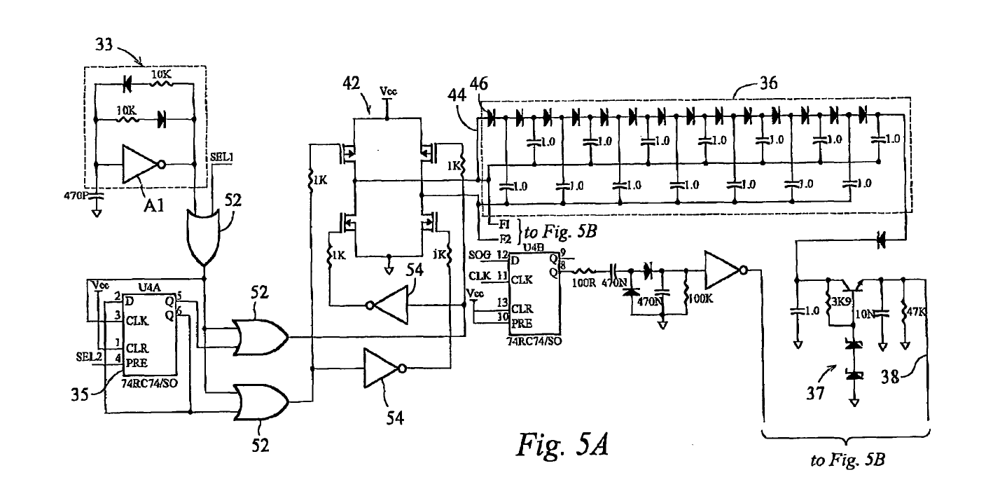

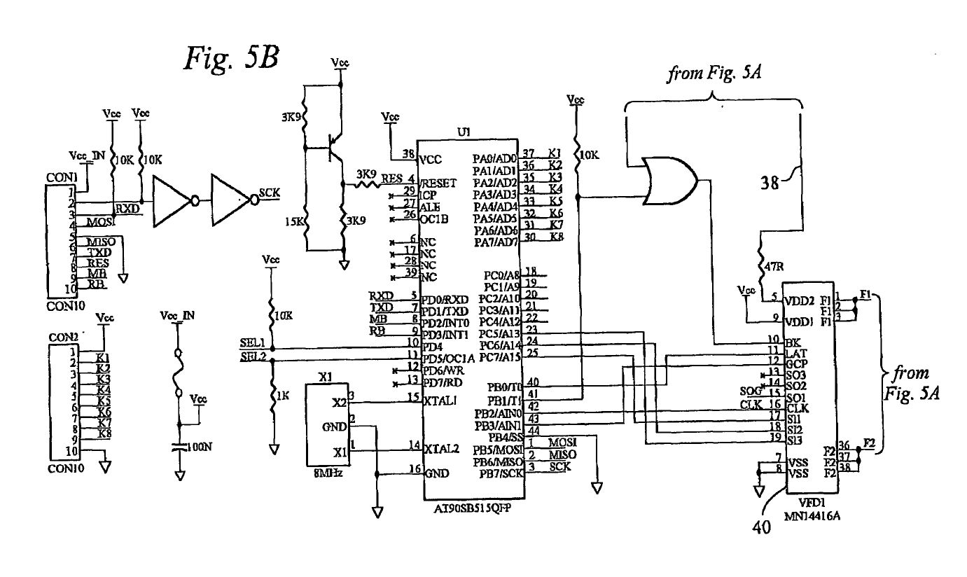

The invention also provides a method substantially as described herein with reference to FIG. 1, FIG. 2, FIG. 3, FIG. 4 or FIG. 5 of the accompanying drawings, and apparatus substantially as described herein with reference to and as illustrated in the accompanying drawings.

Features of the apparatus may be applied to method features of the invention, and vice versa.

Preferred features of the present invention will now be described, purely by way of example, having reference to the accompanying drawings, of which:

FIG. 1 is a schematic diagram of a first example of a power supply according to the invention showing first and second output voltages respectively for the anode/grid and filament cathode of a vacuum fluorescent display;

FIG. 2 is a schematic diagram of a second example power supply for a vacuum fluorescent display with a variable mark/space input to an oscillator forming part of the power supply circuit;

FIG. 3 is a detailed circuit diagram of a preferred configuration of the power supply circuit according to the present invention;

FIG. 4 is a schematic block circuit diagram of an arrangement equivalent to FIG. 3; and

FIG. 5 is a detailed circuit diagram of another configuration of the power supply circuit according to the invention, showing the use of discrete logic components.

In the schematic circuit diagram shown in FIG. 1, an AC drive circuit 10 is connected between the + and ground rails of a DC supply voltage. The outputs 1, 2 of the drive circuit 10 provide the filament/cathode voltage 50 for the vacuum fluorescent display device (not shown). In addition, the outputs are connected to two inputs of a voltage multiplier 11 which is itself connected in series in the + rail. The output of the multiplier, taken across capacitor 12, provides The anode/grid voltage 38 for the display device.

FIG. 2 shows a second example in which the oscillator circuit is implemented by the combination of an oscillator 20, divide-by-two circuit 21, inverter amplifier 22 and a pair of power SAND gates 23, 24. As shown, the oscillator 20 is connected across the + DC rails. Its output is split so that it is connected directly to the upper inputs of both NAND gates 23 and 24 and is passed through the divide-by-two circuit 21 so that it can be connected to the lower input of NAND gate 24 and, via inverter 22, to the lower input of NAND gate 23. Each NAND gate 23, 24 is connected across the power rails.

The output of the oscillator 20 is a square wave 26 with presettable mark/space ratio. The outputs 1, 2 of the power NAND gate circuit consists of a pair of square waves 27, 28 with matching mark/space ratio. The frequency of these square waves is half the frequency of the square wave 26 and is fed to the display to provide the filament/cathode supply voltages and multiplier drive waveform.

As an optional feature, there may be a controllable amplifier 29 connected to the oscillator 20 so as to vary the mark/space ratio, or duty cycle, of the oscillator output to the variations in the supply voltage and thereby the to control the duty cycle of the switching circuit. The effect of this is to improve conversion efficiency and provide wider operating parameters in relation to the given available supply voltage. The oscillator frequency is determined by the values of the capacitors and resistors in the oscillator circuit.

The mark/space ratio can therefore be set to meet the power requirement of the filament.

An embodiment using a specific IC of type BD6621FP-Y is shown in FIG. 3. A nominal 12 VDC supply is connected to the plus rail 31.

An oscillator 33 consists of an inverter amplifier A1 with anti-parallel resistor/diode feedback, the combination providing an output frequency having a fixed mark/space ratio. The oscillator output is split into two paths. The first path connects the oscillator 33 directly to the SELECT input at pin 4 of the IC 34. This input selects whether the IC operates under its own internal clock or an external clock. It should be noted that in prior vacuum fluorescent display device power supplies the pin 4 terminal is usually set to ground or maximum voltage whereas, uniquely, in the present invention it is connected to the oscillator output. It is this new configuration which enables the voltage multiplier stage and filament to be externally mark/space ratio controlled thereby enabling the device to have high efficiency.

As previously mentioned, the internal clock is usually limited to a frequency less than 20 kHz, whereas the external clock frequency, namely that from the oscillator 33, can be several times higher, for example in the region of 100 kHz or even above 200 kHz.

The second path connects the oscillator output to a divide-by-two circuit 35 whose output comprises a square wave of half the input frequency. This output is connected to the EXTERNAL CLOCK input at pin 10 of the IC. The remaining connections to the IC are otherwise conventional. In particular, the pins B0 to B5 are all grounded, as also depicted in the schematic representation of the circuit in FIG. 4.

The outputs OUT1 and OUT2 on pins 6 and 8 generate the filament supply voltage at output terminals F1 and F2. However, since these outputs may overshoot below 0V, they are preferably connected to the terminals P1, F2 via respective pairs of back-to-back diodes D1 to D4 to raise the bias of the filaments and thereby prevent ghost illumination. In addition the voltages on OUT1 and OUT2 are connected to a four stage voltage multiplier 36 consisting of a cascade of diodes and parallel capacitor pairs configured as shown in the drawing. The final output from the voltage multiplier may suffer changes with varying current loads. In order to counteract this, a simple emitter follower regulator 37 may couple the multiplier output to the grid/anode voltage supply terminal 38.

Using the arrangement of FIG. 4, it was found that the input current was 240 mA at 12 VDC and the power supply efficiency was more than 80%. The power dissipation in the BD6621FP-Y was less than 400 mW, allowing derating to 70° C.

FIG. 5 illustrates a further example of a power supply circuit according to the circuit from a switch or switch assembly. Connecting the voltage multiplier in this way allows the power to the display to be completely switched off to reduce consumption. This feature may find useful application in other electronic circuits.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A power supply circuit for a vacuum fluorescent display, the supply circuit including a filament drive and a grid/anode voltage generation circuit combined on a common output drive stage:

2. A circuit according to claim 1, the supply circuit including an oscillator circuit.

3. A power supply circuit for a vacuum fluorescent display comprising an oscillator circuit having a first output for providing a first voltage and a second output for connection to a voltage multiplying circuit.

4. A circuit according to claim 3, wherein the first voltage provides a drive voltage for the filament cathode of the display.

5. A circuit according to any one of claims 2 to 4, further including a voltage multiplying circuit connected to the oscillator circuits the output of the voltage multiplying circuit providing a second supply voltage.

6. A circuit according to claim 5, wherein the output of the voltage multiplying circuit provides a drive voltage for the grid/anode of the display.

7. A circuit according to claim 5 or claim 6, wherein the voltage multiplying circuit has no inductive components.

8. A circuit according to my one of claims 5 to 7, wherein the voltage multiplying circuit comprises a multiple-stage capacitor/diode circuit.

9. A circuit according to any one of claims 5 to 8, wherein the output of the voltage multiplying circuit is stabilised.

10. A circuit according to any one of claims 5 to 9 comprising an emitter-follower circuit connected to the output of the voltage multiplying circuit.

11. A circuit according to any one of claims 2 to 10, wherein the oscillator circuit comprises an AC driver.

12. A circuit according to any one of claims 2 to 11, wherein the oscillator circuit comprises an oscillator connected to a logic circuit, the logic circuit having a fist output for providing the first voltage and a second output for connection to the voltage multiplying circuit.

13. A circuit according to any one of claims 2 to 12, wherein the oscillator circuit comprises:
an oscillator connected to one input of a logic circuit and via a divide-by-two circuit to another input of the logic circuit;
the output of the logic circuit providing the first supply voltage; and
the logic circuit being connected to a voltage multiplying circuit.

14. A circuit according to any of claims 2 to 13, wherein the oscillator circuit comprises an oscillator and an integrated circuit having a mark/space ratio control input to which the oscillator is directly connected.

15. A circuit according to claim 14, wherein a divide-by-two circuit is connected to the output polarity control input of the integrated circuit.

16. A circuit according to any one of claims 2 to 15, wherein means are provided for varying the mark/space ratio or duty cycle ratio of the output of the oscillator.

17. A circuit according to any one of claims 2 to 16, further including a variable amplifier connected to a control input of the oscillator,

18. A circuit according to any one of claims 2 to 17, wherein the oscillator circuit includes an oscillator and a logic circuit comprising a first and a second logic gate, the output of the oscillator being connected to a respective first input of each logic gate, the output of the divide-by-two circuit being connected to a second input of the first logic gate and to the input of a inverter amplifier, the output of said inverter amplifier being connected to the second input of the second logic gate, the outputs of the first and second NAND gates providing drive voltages for the filament/cathode of the display.

19. A circuit according to claim 12, claim 13 or claim 18, wherein the logic circuit includes NAND gates.

20. A circuit according to any one of claims 2 to 19, wherein the oscillating circuit includes an integrated circuit of the type BD6621FP-Y.

21. A power supply circuit for a vacuum fluorescent display, comprising an integrated circuit type BD6621FP-Y and an oscillator connected to the select internal or external clock pin of the integrated circuit.

22. A power supply circuit for a vacuum fluorescent display, said supply circuit being adapted to generate a power supply for each of a filament drive circuit and a grid/anode circuit of said vacuum fluorescent display from a common drive stage.

23. A power supply circuit for a vacuum fluorescent display, comprising a voltage multiplier circuit for connection to a grid/anode circuit of said vacuum fluorescent display, wherein said voltage multiplier circuit has no inductive components.

24. A power supply circuit for a vacuum fluorescent display substantially as herein described with reference to FIGS. 1, 2, 3, 4 or 5 of the accompanying drawings.

25. A display device including a power supply circuit according to any one of claims 1 to 24

26. A method of supplying power to a vacuum fluorescent display using the power supply circuit of any of claims 1 to 24.
